(19) United States
(12) Patent Application Publication
(10) Pub. No.: US 2006/0141962 A1
(43) Pub. Date: Jun. 29, 2006

(54) Selecting/acquiring desired multimedia content

(75) Inventors: Stephen K. Forbes, Raleigh, NC (US); Gregory A. Dunko, Cary, NC (US)

Correspondence Address: COATS & BENNETT/SONY ERICSSON, 1400 CRESCENT GREEN, SUITE 300, CARY, NC, 27511, US

(73) Assignee: Sony Ericsson Mobile Communications AB

(21) Appl. No.: 11/141,569

(22) Filed: May 31, 2005

Related U.S. Application Data
(60) Provisional application No. 60/639,216, filed on Dec. 23, 2004.

(51) Int. Cl. H04B 1/18

(52) U.S. Cl. 455/186.1

(57) ABSTRACT

A consumer electronics device comprises a receiver to receive a broadcast signal transmitted by a commercial broadcast radio station, a controller, and a communications interface. The broadcast radio signal comprises multimedia content that may be rendered to the user and information identifying the multimedia content. The controller generates a request to download the multimedia content using the information identifying the multimedia content. The communications interface transmits the request to a server in a communications network, which downloads the requested multimedia content to a user-designated destination device if the content is available.

### RELATED APPLICATIONS

This application claims priority under 35 U.S.C. § 119(e) from the following U.S. provisional patent application: Application Ser. No. 60/639,216 filed Dec. 23, 2004, which is expressly incorporated in its entirety by reference herein.

### BACKGROUND

The present invention relates generally to consumer electronics devices, and particularly to consumer electronics devices capable of sending and receiving data communications and equipped with broadcast radio receivers.

Commercial broadcast radio stations, such FM radio stations, may use a system known as a Radio Data System (RDS). RDS is a standard for sending small amounts of digital information using conventional FM radio broadcasts. RDS standardizes several types of information transmitted by the broadcast radio stations, such as the identity of the particular radio station, type of programming, and the name of an artist and/or a particular song. Suitably equipped radio receivers can receive and decode this information for display to the user. As those skilled in the art will know, RDS is used widely throughout Europe. The U.S. has an equivalent standard known as Radio Broadcast Data System (RDBS), which differs only slightly from its European counterpart. Thus, for the purposes herein, the European standard RDS and the U.S. standard RBDS are commonly referred to as “RDS.”

Currently, commercial broadcast radio stations transmit their programming (e.g., music) and RDS data as distinct signals. Some consumer electronics devices available on the market also include integrated radio receivers that permit a user to listen to these commercial broadcast radio stations. These receivers, like those available for home and vehicle use, can be equipped with circuitry to receive, extract, decode, and display the received RDS data streams on a display for the user. This enhances the user's experience by allowing the user to be aware of useful information such as the radio station identification, artist/title of the song currently being played, audience participation call in phone numbers for talk shows, URLs, and the like. However, an opportunity exists to use the information extracted from the RDS stream to purchase and/or download the multimedia content.

### SUMMARY

The present invention provides a consumer electronics device that receives a commercially broadcast radio signal from a broadcast radio station. The commercial broadcast signal may be transmitted by an AM or FM radio station, for example, and is a composite signal that includes multimedia content and information that identifies the multimedia content to the user. In one embodiment, the multimedia content is a song transmitted by an FM radio station and the decoded information is text data that identifies the name of the song and the performing artist.

Upon receipt of the radio signal, an audio processing circuit renders the multimedia content to a user of the device. A processing module extracts and decodes the RDS information identifying the multimedia content, and sends the decoded RDS information to a controller, which typically sends it to a display. Either automatically or upon user request, the controller generates a request using the decoded information to determine if the multimedia content is available for purchase and/or download from one or more content providers. The content providers may or may not be affiliated with the radio broadcast station. If the multimedia content is available, the device may generate an alert to inform the user. Should the user wish to download the content, the controller generates a request to a content server to download the content. The content server then downloads the multimedia content to the consumer electronics device, or alternatively, to some other destination specified by the user. If the content is not available, or where a device has limited data connectivity, the decoded information could be stored in memory of the device. In addition, a short audio sample may also be stored along with the decoded information. The controller could then use the stored information to generate the purchase/download request at a later time.

In addition to using the decoded information to purchase/download multimedia content, the decoded information may also include other information, such as phone numbers and Uniform Resource Locators (URLs). In these embodiments, the user may use the decoded information to establish phone calls or access websites, respectively.

### BRIEF DESCRIPTION OF THE DRAWINGS

FIG. 1 illustrates a consumer electronics device according to one embodiment of the present invention.

FIG. 2 illustrates circuitry that enables receivers to receive and decode RDS data streams according to one embodiment of the present invention.

FIGS. 3A and 3B illustrate some RDS messages that may be used by a wireless communications device according to one embodiment of the present invention.

FIG. 4 illustrates a possible system in which a consumer electronics device may operate according to the present invention.

FIG. 5 illustrates a method of using RDS data to download multimedia content according to one embodiment of the present invention.

FIG. 6 illustrates an alternative method where content availability is automatically determined when RDS messages are decoded.

FIG. 7 illustrates a method of using RDS data stored in a history file to download multimedia content according to an alternate embodiment of the present invention.

FIG. 8 illustrates an alternate embodiment of the consumer electronics device, and methods by which the consumer electronics device may request and receive multimedia content.

### DETAILED DESCRIPTION

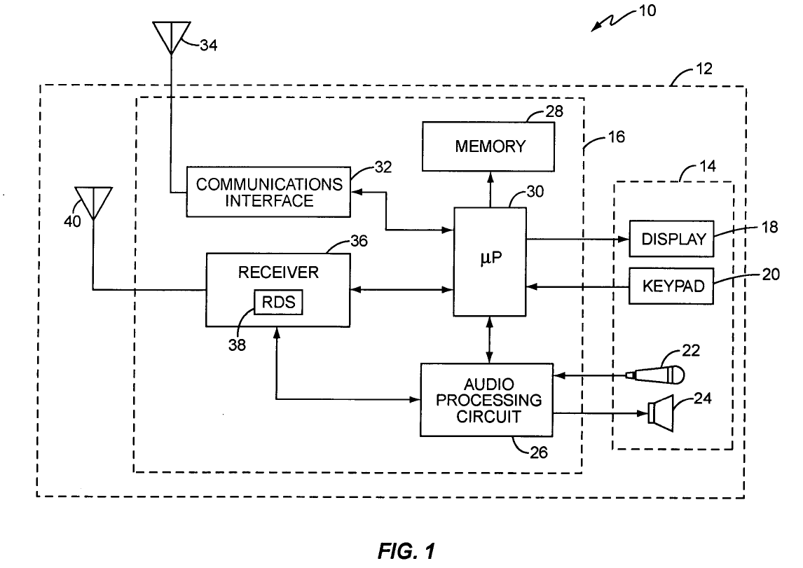

FIG. 1 illustrates a consumer electronics device according to one embodiment of the present invention, and is generally indicated by the number 10. FIG. 1 illustrates the device in terms of a cellular telephone; however, this is merely for illustrative purposes. Those skilled in the art will readily appreciate that the present invention is applicable to any consumer electronics device capable of sending and receiving data communications, and receiving commercially broadcast radio signals. Thus, as used herein, consumer electronics devices is intended to include devices such as Personal Digital Assistants (PDAs), satellite telephones, Personal Communication Services (PCS) devices, palm computers, or the like.

As seen in FIG. 1, cellular telephone 10 comprises a housing 12, a user interface 14, and communications circuitry 16. User interface 14 provides a user with the necessary elements to interact with cellular telephone 10, and includes a display 18, a keypad 20, a microphone 22, and a speaker 24. Display 18 permits users to view dialed digits, call status, menu options, and service information typically associated with wireless communications. Display 18 also displays decoded RDS data received from a commercial broadcast radio station, such as the name of an artist and the title of a song currently being played by the radio station. Keypad 20 is disposed on a face of cellular telephone 10, and includes an alphanumeric keypad and other input controls such as a joystick, button controls, or dials. Keypad 20 allows the operator to dial numbers, enter commands, and select options from menu systems, as well as permit the user to tune to a selected broadcast radio station. Microphone 22 converts the user's speech into electrical audio signals, and speaker 24 converts audio signals into audible sounds that can be heard by the user.

Communications circuitry 16 comprises a controller 30, memory 28, an audio processing circuit 26, a communications interface 32, and a receiver 36 having an antenna 40. Memory 28 represents the entire hierarchy of memory in cellular telephone 10, and may include both random access memory (RAM) and read-only memory (ROM). Computer program instructions and data required for operation of cellular telephone 10 are stored in non-volatile memory, such as EPROM, EEPROM, and/or flash memory, and may be implemented as discrete devices, stacked devices, or integrated with controller 30.

Controller 30 controls the operation of cellular telephone 10 according to programs stored in memory 28. The control functions may be implemented, for example, in a single microprocessor, or in multiple microprocessors. Suitable microprocessors may include general purpose and special purpose microprocessors, as well as digital signal processors. Controller 30 may interface with audio processing circuit 26, which provides basic analog output signals to speaker 24 and receives analog audio inputs from microphone 22. As described in more detail below, controller 30 may be configured to generate download requests for multimedia content based on decoded RDS data received from a commercial broadcast radio station.

Cellular telephone 10 also comprises a communications interface 32. In FIG. 1, the communications interface 32 is embodied as a long-range transceiver coupled to antenna 34 for transmitting and receiving cellular signals to and from one or more base stations in a wireless communications network. The transceiver is a fully functional cellular radio transceiver, and operates according to any known standard, including Global System for Mobile Communications (GSM), TIA/EIA-136, cdmaOne, cdma2000, UMTS, and Wideband CDMA. The transceiver preferably includes baseband-processing circuits to process signals transmitted and received by the transceiver. Alternatively, the baseband-processing circuits may be incorporated in the controller 30.

As will be described in more detail later, the present invention does not require that the communications interface 32 be an integrated cellular transceiver. In alternate embodiments, communications interface 32 is embodied as a short-range transceiver, or alternatively, as an interface port that facilitates connection to a separate device communicatively connected to a publicly accessible IP network. Whatever the embodiment, however, communications interface 32 may be configured to transmit requests generated by the controller, and to receive the requested multimedia content.

Receiver 36 is coupled to antenna 40, and receives and demodulates signals broadcast by a radio station, such as an AM or FM radio station, for output to the user over speaker 24. To receive the signals, receiver 36 must be tuned to the particular transmit frequency assigned to the broadcast radio station of interest. As is known in the art, receivers may use a resonance circuit to separate a radio signal of interest from the thousands of radio signals that permeate the environment. For example, receiver 36 may be tuned to a radio frequency of an FM radio station, such as 96.1 MHz, or of an AM radio station, such as 680 KHz. In these cases, receiver 36 will be tuned such that it selects only those radio signals being transmitted at 96.1 MHz or 680 KHz, respectively.

Receiver 36 is suitable for use with RDS systems, and thus, may be equipped with an RDS module 38 in order to decode the RDS data. RDS module 38 may be typical of any circuitry known in the art that is able to decode received RDS information. Thus, only a brief overview of the circuitry is contained herein. However, for more information on the circuitry, messaging, encoding/decoding, or on RBDS or RDS in general, the interested reader is directed to the RBDS and RDS standards entitled “United States RDBS Standard,” Apr. 9, 1998 produced by the RBDS Subcommittee of the National Radio Systems Committee (NRSC), and the European Broadcasting Union (EBU)/Cenelec Standard EN50067:1998 “Specification of the Radio Data System,” both of which are incorporated herein by reference.

It should be understood that these above-mentioned standards mostly describe RDS as it applies to FM broadcasts. However, these standards documents also include language indicating that the RDS system will be applied to AM broadcasts as well. Therefore, those skilled in the art will realize that the following discussion does not limit the use of the present invention to RDS data broadcast over an FM frequency.

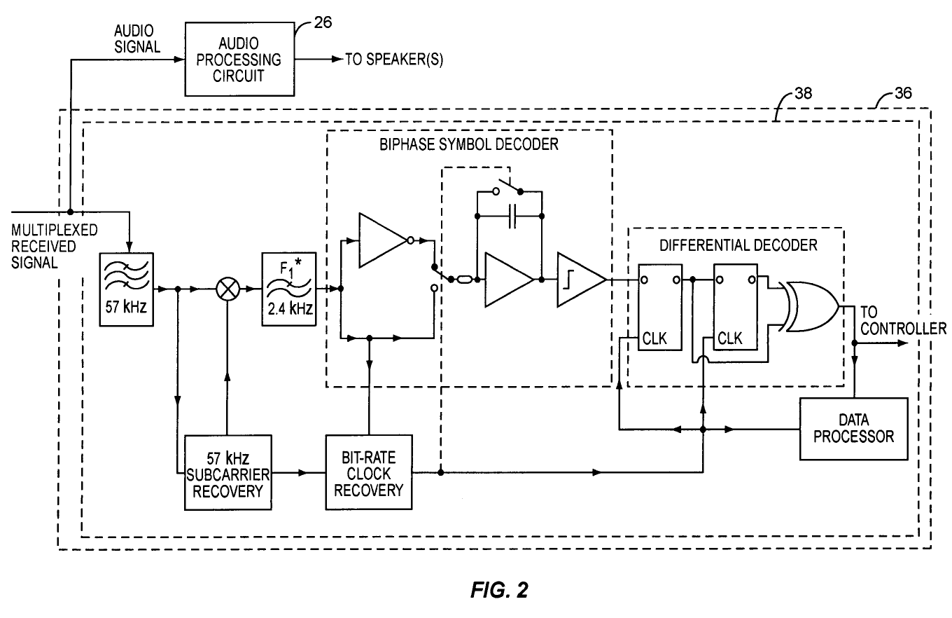

As seen in FIG. 2, the audio portion of the multiplexed signal received from an FM broadcast radio station is sent to the audio processing circuit 26, which will render the signal as audible sound over speaker 24. The received signal is also sent to RDS module 38 for processing. As is known in the art, RDS module 38 contains circuitry to decode the 57 kHz subcarrier signal specified by the RDS standards, and extracts any digital information carried thereon. Once decoded, the information may be sent by controller 30 to display 18 for display to the user.

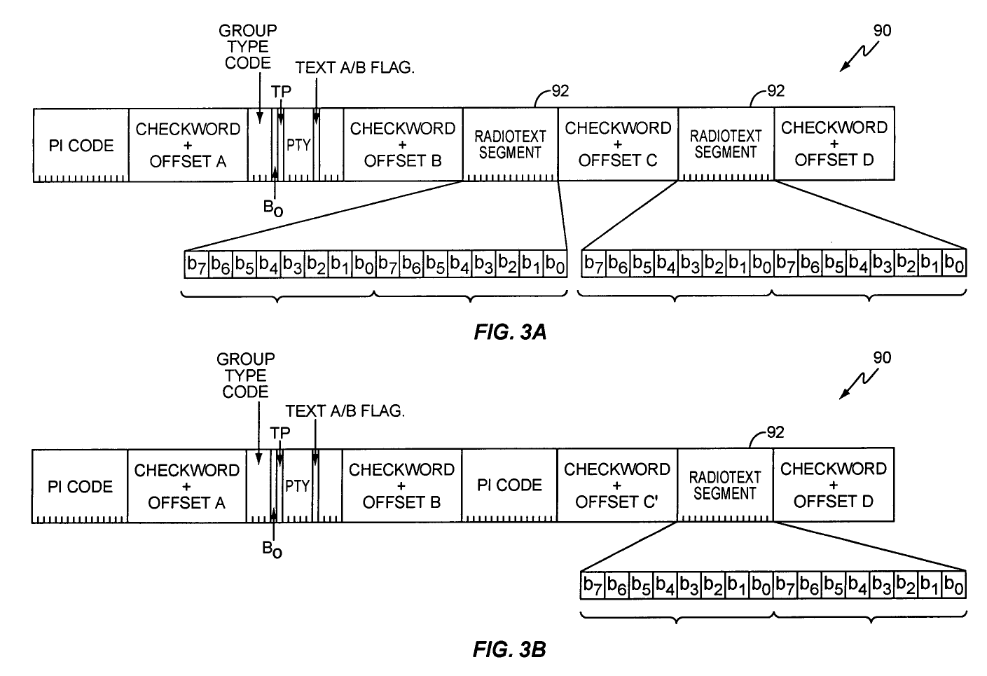

As seen in FIG. 3, the RDS data transmitted by the broadcast radio stations may be formed as messages. In one embodiment, the message includes data that identifies the name of a song currently being transmitted by the broadcast radio station, as well as the artist. In other embodiments, however, the message may include data that specifies a phone number or URL. These short messages transmitted by the broadcast radio station are known as RadioText (RT) messages 90.

There are two types of RT messages 90—group 2A messages as seen in FIG. 3A, and group 2B messages as seen in FIG. 3B. The format differences between group 2A and 2B messages are not material to the present invention, other than the fact that they contain a different number of text segments 92. However, RDS module 38 is configured to distinguish between the two groups by analyzing the “GROUP TYPE CODE” bits, and thus, is able to properly decode RT message 90 regardless of the group.

The text segments 92 contain the bits (b₀ . . . bₙ) that carry the character data to be displayed to the user. For example, in one embodiment of the present invention, the bits b₀ . . . bₙ in text segments 92 include character data that identifies the name of the song and artist. In another embodiment, the bits b₀ . . . bₙ in text segment 92 include character data that identifies a URL that specifies a server from where a particular song may be downloaded or purchased. In other embodiments, the bits b₀ . . . bₙ in text segment 92 may include character data that indicates a phone number that the user can call to download or purchase the song being played. Because each character in the message is denoted using 8-bits b₀ . . . b₇, broadcast radio stations may transmit the RT messages 90 several times in succession to ensure proper reception of all characters in the message. The text segments 92 in Group 2A messages comprise four characters each, and can be used to send messages of up to 64 characters in length. In contrast, the text segment 92 in Group 2B messages comprise only two characters each, and can be used to send messages of up to 32 characters in length.

To determine whether a new RT message 90 is being transmitted, RDS module 38 analyzes the “TEXT A/B” flag in each received RT message 90. This may occur, for example, between successive songs. If RDS module 38 detects a change in the flag (e.g., from a binary “0” to a binary “1”), a signal is generated to clear the display. The character data indicated in text segments 92 are then displayed as new text to the user. If the TEXT A/B flag remains constant, however, the character data in the text segments 92 are sent to display 18. The user may view this resultant character data, for example, as a “scrolling” message across the display 18. In addition, detecting a change in the flag could also “trigger” controller 30 to generate an availability request for the next song.

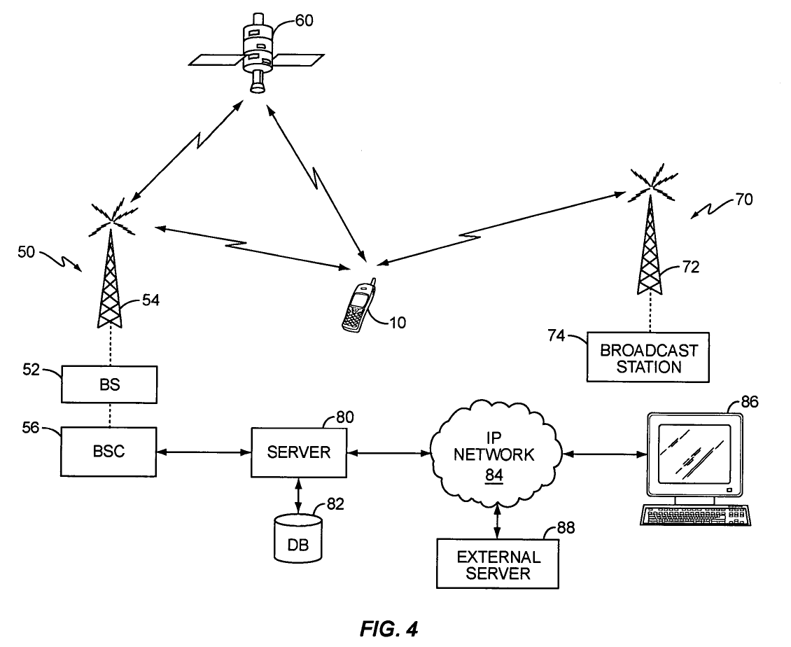

FIG. 4 illustrates a possible system in which cellular telephone 10 may operate. As seen in FIG. 4, cellular telephone 10 communicates with remote parties via a wireless communications network 50 that includes a base station (BS) 52 coupled to an antenna 54, and a base station controller (BSC) 56. Network 50 may be any private or public wireless communications network known in the art that operates according to any known standard, including Global System for Mobile Communications (GSM), TIA/EIA-136, cdmaOne, cdma2000, UMTS, and Wideband CDMA. As such, a detailed description of the components of network 50 is not required here. However, as will be described in more detail below, BSC 56 or other network entity may interface with a server 80 to forward download requests for music and other multimedia content originating from the cellular telephone 10 according to the present invention.

Cellular telephone 10 may receive broadcast radio signals from a commercial broadcast radio network 70, or alternatively, a satellite network. A satellite network includes one or more satellites 60 in orbit around the earth that transmits commercial radio programming, such as music and/or talk radio to users of cellular telephone 10. Companies such as SIRIUS and XM RADIO are two examples of companies that provide users with commercial satellite radio programming, usually for a monthly subscription fee. In the event that the user wishes to receive satellite signals, receiver 36 would comprise a suitable satellite receiver that operates in the GHz range.

Network 70 also provides users with commercial radio programming, and typically includes a broadcast radio station 74 coupled to an antenna 72. Broadcast radio station 74 may be any publicly or privately owned broadcast radio station such as an AM and/or FM radio station. The radio signals broadcast by the radio station 74 are typically modulated sine waves that carry information representative of multimedia content, such as music. For the receiver 36 to receive the radio signals broadcast from radio station 74, receiver 36 would comprise a receiver that operates in the AM radio band (between 535 KHz and 1.7 MHz in the US) or the FM radio band (between 88 MHz and 108 MHz in the US), or both. It should be understood that the AM/FM radio bands discussed above are for illustrative purposes only, and that these radio bands may be frequencies appropriate for other regions.

Server 80 may be any computing device known in the art that is communicatively connected to BSC 56. Server 80 may include one or more application programs that fulfill user requests to download songs or other media content, as well as provide billing and authentication services. Server 80 may include a database 82 that stores music as audio files in proprietary or well-known formats such as WAV, MP3, or MP4, as well as user profiles and other information as needed or desired to fulfill user download requests. User profile data may contain such information as user identification, mobile device identification, subscription information, account balance information, billing information, and the like. As is known in the art, database 82 may be separate from or integrated with server 80.

Computing device 86 and external server 88 are communicatively linked to server 80 via one or more public or private IP networks. In one embodiment, computing device 86 is associated with the user of cellular telephone 10, for example, the user's home PC. As described later in more detail, the user of cellular telephone 10 can designate computing device 86 as a destination to receive downloaded content. In another embodiment, external server 88 is a third party content server that stores multimedia content for download by the user, or has access to other network entities that store the multimedia content. In these embodiments, which are described below in more detail, server 80 may be communicatively connected to external server 88.

As previously stated, conventional receivers decode the transmitted RDS data stream to extract the character data from the text segments 92 for display only. This enables the user to view the name of the artist and title of a song currently being transmitted by radio station 74. According to the present invention, however, this character data or other indicator carried in the RDS data stream may be used to generate a request to purchase or download a song or other programming being transmitted by radio station 74. The song being downloaded or purchased may be stored at a content server, such as external server 88, that may or may not be affiliated with the broadcast radio station transmitting the programming.

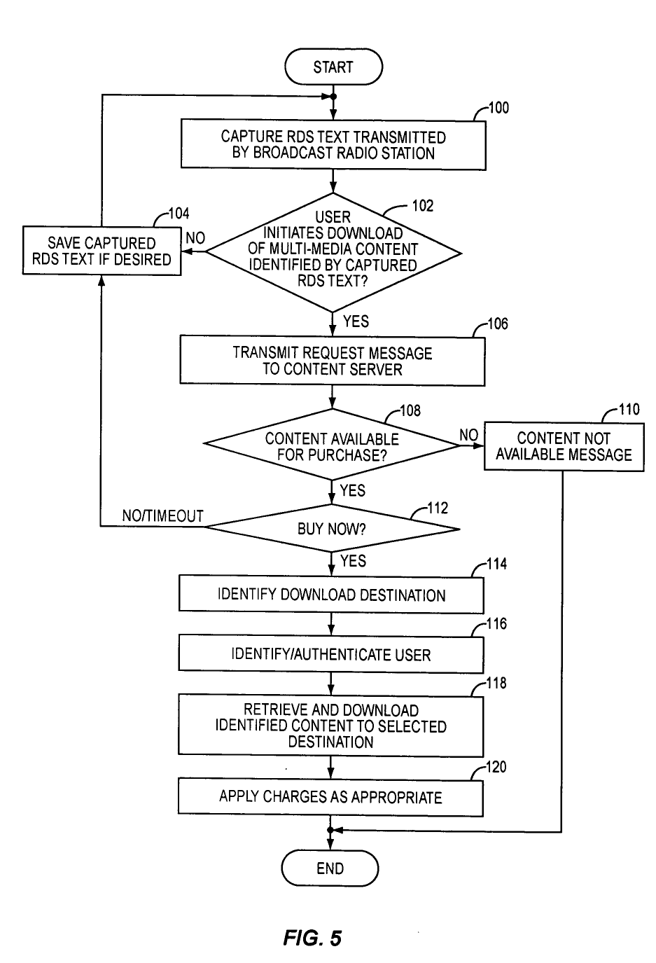

FIG. 5, for example, illustrates a method according to one embodiment of the present invention by which a song currently being transmitted by an FM radio station is received by cellular telephone 10, and purchased for download by the user. The method begins with the RDS module 38 decoding and extracting the character data from text segments 92 in one or more received RT messages 90 (box 100). In this embodiment, text segments 92 carry information that indicates the name of the song and/or the artist. The character data is then sent to display 18, and to controller 30. Upon hearing the song, the user may decide to purchase the song and initiate a download request (box 102). This may be done, for example, by actuating one or more keys on keypad 20, or by selecting an option from a menu displayed on display 18. If the user does not initiate a download, the decoded RDS data may be written to memory 28 for later retrieval (box 104), as will be described later in more detail.

If the user requests a download, controller 30 assembles a request message with the appropriate decoded RDS data, and transmits the request message to server 80 via cellular network 50 (box 106). Server 80 analyzes the message to identify the requested song and/or artist, and determines whether the requested song is available for purchasing and/or downloading (box 108). This may be accomplished, for example, via a query-response exchange between server 80 and database 82 and/or external server 88. One skilled in the art will realize that external server 88 could represent a content provider, and that multiple content providers might be consulted in the process of determining availability for a specific item like the song currently being broadcast. If the requested content is not available, server 80 may return a “CONTENT NOT AVAILABLE” message to cellular telephone 10 for display to the user (box 110). Otherwise, server 80 may send a request to the user asking the user to confirm the purchase (box 112) prior to applying charges and downloading the content.

If the user does not initiate the purchase, or does not confirm the purchase within a predetermined time (box 112), controller 30 may save the RDS text in memory 28 for later retrieval (box 104), as will be described later in more detail. If the user confirms the purchase, server 80 identifies a download destination, which in this embodiment is cellular telephone 10 (box 114), and may identify/authenticate the user (box 116). Identification/authentication may be accomplished using any known method. For example, the download request message may include the Electronic Serial Number (ESN) or International Mobile Equipment Identity (IMEI) associated with cellular telephone 10 and/or other information such as the telephone number of cellular telephone 10. Upon receipt, server 80 compares this information against subscriber information stored in database 82, and identifies and/or authenticates the user based on a match/no-match condition. In an alternate embodiment, server 80 originates an authentication/response exchange with the user by prompting the user to enter a PIN. The user may enter the PIN using keypad 20 and send it back to server 80 for comparison with the subscriber data. In yet another embodiment, a certificate stored on cellular telephone 10 (e.g., on a SIM card) may be transmitted to server 80 with the request. Server 80 could have access to information corresponding to the certificate stored on device 10, and identify/authenticate the user based on whether the certificate is valid. Once the user has been identified/authenticated, server 80 retrieves the requested song for download to the user (box 118). When the download is complete, server 80 may apply charging as appropriate (box 120).

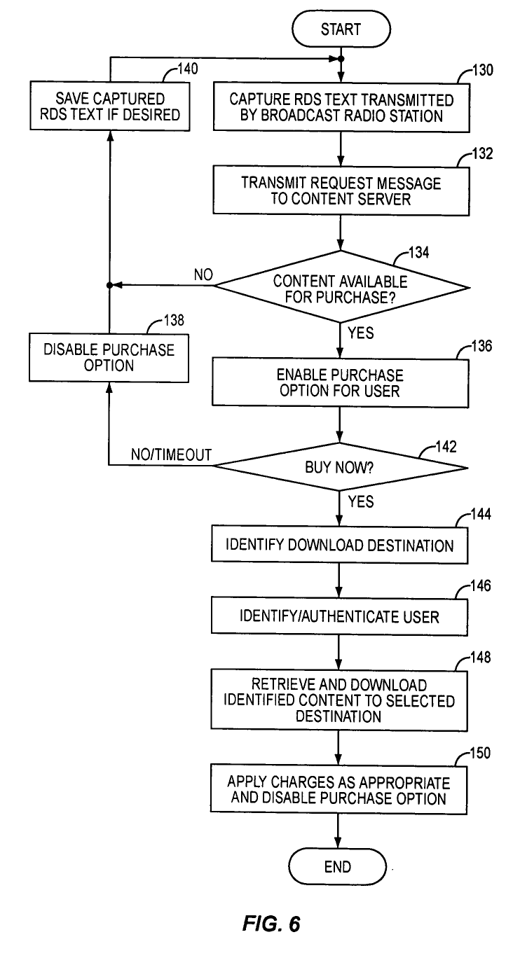

Determining the availability of a song or other multimedia content is not contingent upon user input. FIG. 6, for example illustrates a method according to another embodiment of the present invention where controller 30 automatically checks with the server 80 or other network entity to determine content availability without requiring user input. This allows the user to only initiate a download for content that is available.

In this embodiment, the RDS module 38 decodes and extracts the character data from text segments 92 in one or more received RT messages 90 (box 130). Controller 30 than automatically generates a request message to server 80 to determine whether the multimedia content being rendered to the user and identified by the RDS information is available to the user for download (box 132). If the content is not available (box 134), the RDS information and an audio snippet can be saved in memory as previously described (box 140). However, if the content is available (box 134), controller 30 could visually and/or audibly alert the user, and enable a “download mechanism” (box 136), such as a menu or control (e.g., softkey or command button) that permits the user to purchase/download the content. If the user wishes to download the content (box 142), the user could identify the destination (box 144) and be authenticated (box 146). The user could then initiate a purchase/download of the content (box 148), and appropriate charges could be applied (box 150). Alternatively, if the user does not wish to download the content (box 142), controller 30 could disable the download mechanism (box 138) if it is enabled, and save the RDS information, along with an audio snippet, if desired (box 140).

As is known in the art, charging the user for the download of a selected song may be accomplished in a variety of ways. In one embodiment, the user of cellular telephone 10 subscribes to the service and pre-pays some amount into an account. Each time a user downloads a song, an appropriate amount for the song could be deducted from the account. In another embodiment, the user pays a periodic subscription fee. So long as the user's subscription is current, the user may use the download service to download songs according to the present invention. In yet another embodiment, the user may transmit an account number or credit card number to charge. In these cases, it is assumed that cellular telephone 10 and server 80, as well as network 50, are equipped with the requisite hardware and software to enable encrypted transmissions. In still other embodiments, the operator of the service could charge appropriate amounts to the user's telephone bill.

In addition, the user may provide the information needed to fulfill a request manually or automatically. In some embodiments, for example, the user manually sends the information used by server 80 to identify the download destination and/or identify/authenticate the user. This may be done in response to messages received via network 50. In alternate embodiments, this information may be pre-configured by the user and stored as a user-profile on cellular telephone 10 or on database 82, or even on an entity in network 50, such as a Home Location Register (not shown). In cases where user-profile information is stored on cellular telephone 10, controller 30 may automatically send this user-profile information as part of the original download request message, or in response to a message requesting the information sent by server 80/network 50. In cases where the information is accessible to server 80, such as when it is stored in database 82, server 80 could simply retrieve the user-profile information as necessary. This latter method would have a benefit in that it facilitates decreased message traffic, and thus, requires fewer resources.

Further, cellular telephone 10 need not be the only download destination. For example, the user may wish to order the song using cellular telephone 10 and have it downloaded to computing device 86, which in this case is the user's home PC. In these cases, the user could provide server 80 with the IP address, or a user-friendly label associated with the IP address, either manually or as part of the user-profile information. Provided server 80 had access, server 80 could direct the download to the user's home PC or other identified destination.

In addition, it is not necessary that the songs available for purchase/download be stored on server 80 or database 82. In some embodiments, the songs may be stored on external server 88, or on another network entity to which server 80/server 88 has access. The text segments 92 of RT message 90 could include a URL or IP address identifying server 80/external server 88 as the server from where the song currently being rendered to the user can be purchased. Controller 30 could transmit this information to server 80/server 88, which could access the entity storing the desired song for download to a user-selected destination.

The aforementioned embodiments of the present invention permit the user to purchase/download a song or other multimedia content being rendered to the user. In some scenarios, however, it may be impractical for the user to immediately initiate a download. For example, some jurisdictions have made it illegal to operate a wireless communications device while driving a car. Therefore, controller 30 may be configured to store the text extracted from RT message 90 in a “history-bookmark” file in memory 28. Controller 30 may also store a snippet of the audio in memory 28, and associate the snippet with the text saved in the bookmark file. For example, controller 30 could digitize a sample of the song being rendered to the user, and save the digitized sample using methods known in the art. The user can then access the bookmark file at an appropriate time to hear and/or purchase the previously rendered content. Listening to the audio snippet might be useful to the user in making purchasing decisions. Of course, the size of the digitized sample stored in memory 28 would be limited by the amount of memory available to cellular telephone 10, or alternatively, by preprogrammed logic in controller 30.

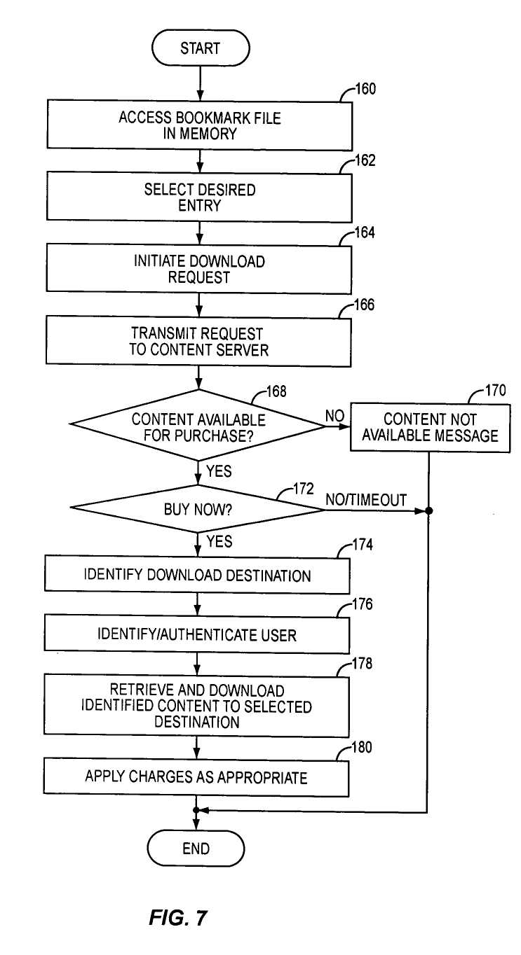

FIG. 7 illustrates one such embodiment where a user accesses the bookmark file in memory (box 160) to select a desired entry (box 162). The entries may be displayed as a scrollable list and may include information such as the name of an artist and title of a song, a URL identifying a server from where the song may be purchased/downloaded, or a phone number identifying a contact that may be dialed by controller 30. When the user selects a desired song, controller 30 may render the snippet of the audio for the user if one was saved in memory 28. If the user wishes to purchase the song, the user initiates the download request (box 164). Controller 30 transmits the request to the content server (box 166), which checks the availability of the requested content (box 168). If the content is not available, controller 30 may display a “CONTENT NOT AVAILABLE” message (box 170). Otherwise, controller 30 may display a prompt asking the user to confirm the purchase (box 172). If the user confirms the purchase/download, the content server may identify the download destination (box 174), identify/authenticate the user (box 176), and retrieve and download the identified content to the selected destination (box 178) as previously described. Appropriate charges may also be applied (box 180). In embodiments where content availability is automatically checked when RT message 90 is decoded, the availability as well as the content provider (server 80 or server 88) may have already been determined.

It should be understood that while FIG. 6 illustrates the user accessing the history-bookmark file from memory 28, the present invention is not so limited. The user may also store the history-bookmark file on server 80, server 88, or on any entity in network 50, such as a home location register (HLR). In addition, the decoded RDS information may also include information such as URLs and phone numbers. This information may be parsed from RT message 90 and stored in memory 28. The information may than be recalled from memory 28 by the user, and used to launch a web browser application or initiate a call to the stored phone number.

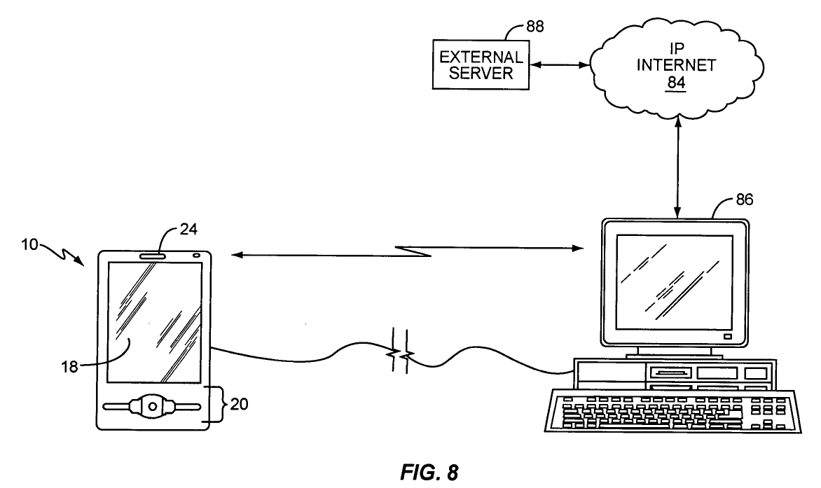

The previous embodiments illustrate the present invention as having an integrated cellular transceiver to transmit the download requests and receive the requested content. However, the present invention does not require that the communications interface 32 be embodied as a long-range transceiver. FIG. 8, for example, illustrates alternate embodiments wherein the consumer electronics device comprises a Personal Digital Assistant (PDA) 10. PDA 10 includes the components described in FIG. 1, but may not provide long-range communications capabilities to the user. However, PDA 10 does receive a broadcast signal comprising multimedia content and RDS data.

In one alternate embodiment, the communications interface 32 of PDA 10 may comprise a short-range transceiver that transmits and receives signals to and from a corresponding short-range transceiver included with computing device 86 (e.g., the user's home PC). The short-range transceivers may be BLUETOOTH transceiver or RF transceivers operating according to the IEEE 802.11(b) or 802.11(g) standards. Other wireless technologies, such as infra-red, may also be used to communicate signals over short distances. In some cases, controller 30 in PDA 10 may decode and save the received RDS data and/or digitized sample in memory 28. Later, the user may establish a short-range communications link and upload the saved RDS data and digitized samples to computing device 86 (e.g., the users home PC). Once uploaded, the user may use an application program, such as a browser, to select a desired song. Computing device 86 could then access external server 88 via IP network 84 to request and download the content as described above. In other cases, controller 30 on PDA 10 may generate the download request and transmit the request to external server 88 using computing device 86 only as an intermediary communications device. As stated above, the RDS data may be a URL or IP address that identifies the external server 88, and the requested content may be downloaded to a destination of the user's choice.

In another alternate embodiment, communications interface 32 may comprise an interface port that permits a user to connect PDA 10 to a docking station or cable that is connected to computing device 86. The user may “dock” or otherwise connect PDA 10 to computing device 86, and use computing device 86 to request and download multimedia content via the IP network 84 to a destination device specified by the user.

Additionally, FIG. 1 illustrates RDS module 38 as being integrated with the receiver 36. However, those skilled in the art will readily appreciate that the present invention is not so limited. In some embodiments, for example, RDS module 36 may be integrated with controller 30. Further, it is not requisite to the present invention that RDS module 38 or controller 30 extracts the information from text segments 92. In some embodiments, controller 30 simply transmits the entire RT message 90 as they are received to server 80 as part of the download/request message. In these cases, an entity in network 50 or server 80 may comprise circuitry and software that permits the decoding and extraction of the information from RT message 90.

Additionally, the present invention is not limited to RDS information transmitted by suitably equipped FM radio station. Rather, the present invention may also be practiced where the RDS information comes from a satellite or AM radio station. In cases where a satellite transmits both the music and the RDS data, cellular telephone 10 could be a dual-mode satellite phone. Moreover, the content for purchase/download is not limited strictly to music, but instead, may also be video or images or other multi-media content. In these cases, RT message 90 may carry a URL identifying a server where the content is stored and a filename identifying the content. In addition, the present invention is not limited to the name of the artist and/or song, nor is the invention limited to the use of only group 2A and/or 2B messages. The RBDS and RDS specifications identify other group types that broadcast radio station 74 may use to send information. Further, the present invention is not limited simply to RDS data carried in a sub-carrier signal, but may be any text embedded in a signal that identifies the content being rendered to the user.

Those skilled in the art will also appreciate that the present invention is not limited to the AM and FM frequency bands explicitly stated above. Rather, various geographical regions and technologies may define and support commercial radio transmissions at frequencies other than those described above. Thus, the present invention may also operate to receive broadcast signals within any radio frequency range.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A consumer electronics device comprising:
a receiver to receive a broadcast signal that includes multimedia content and information identifying the multimedia content;
a processing circuit to render the multimedia content to a user;
a communications interface to transmit a request to download the multimedia content being rendered to the user based on the information identifying the multimedia content.

2. The device of claim 1 further comprising a module to decode the information identifying the multimedia content.

3. The device of claim 1 further comprising a controller to generate the request message based on the information.

4. The device of claim 3 further comprising a display, and wherein the information identifying the multimedia content includes text data that is sent to the display.

5. The device of claim 3 wherein the multimedia content comprises a song, and the information includes the title of the song and the name of an artist associated with the song.

6. The device of claim 3 wherein the multimedia content comprises video content, and the information includes the name of the video content.

7. The device of claim 3 wherein the information comprises an IP address of a server that stores a digitized representation of the multimedia content being rendered to the user.

8. The device of claim 3 wherein the controller generates an automatic request to determine whether the multimedia content identified by the information is available.

9. The device of claim 8 wherein the controller generates the automatic request responsive to a flag in the received broadcast signal.

10. The device of claim 3 wherein the controller generates a request to determine whether the multimedia content identified by the information is available responsive to user input.

11. The device of claim 3 further comprising memory, and wherein the controller further stores the information identifying the multimedia content in the memory.

12. The device of claim 11 wherein the controller further saves a digitized sample of the multimedia content being rendered to the user, and links the digitized sample to the information stored in memory.

13. The device of claim 11 wherein the controller generates a request to determine whether the multimedia content identified by the information stored in memory is available.

14. The device of claim 3 wherein the controller indicates an availability status of the multimedia content currently being rendered to the user.

15. The device of claim 14 wherein the controller generates the request to download the multimedia content identified by the information based upon the indicated availability

16. The device of claim 3 wherein the controller is configured to send user profile information with the download request.

17. The device of claim 3 wherein the controller is configured to send a user-designated destination to receive the downloaded multimedia content.

18. The device of claim 1 wherein the communications interface comprises a wireless transceiver that transmits the download request to a server in a communications network.

19. The device of claim 1 wherein the communications interface comprises an interface port that connects to a computing device to transmit the download request to a server in a communications network.

20. The device of claim 1 wherein the communications interface receives the requested multimedia content responsive to the request message.

21. The device of claim 1 wherein the broadcast signal is received from a satellite.

22. The device of claim 1 wherein the broadcast signal is received from a commercial broadcast radio station.

23. A method of downloading multimedia content using a consumer electronics device, the method comprising:
receiving a broadcast radio signal comprising multimedia content and information identifying the multimedia content;
rendering the multimedia content to a user of the consumer electronics device;
sending a request to download the multimedia content being rendered to the user based on the decoded information.

24. The method of claim 23 further comprising decoding the information identifying the multimedia content and displaying the decoded information to the user.

25. The method of claim 24 wherein decoding the information identifying the multimedia content comprises decoding a message received with the multimedia content, and extracting text data from the message that identifies the multimedia content.

26. The method of claim 23 further comprising generating the download request based on the information identifying the multimedia content.

27. The method of claim 23 further comprising automatically generating a request to determine whether the multimedia content is available for download by the user.

28. The method of claim 27 further comprising automatically generating the request to determine whether the multimedia content is available for download by the user responsive to receiving a flag in the broadcast radio signal.

29. The method of claim 23 further comprising generating a request to determine whether the multimedia content is available for download by the user responsive to user input.

30. The method of claim 23 further comprising saving the information identifying the multimedia content in memory.

31. The method of claim 30 further comprising saving a digitized sample of the multimedia content in the memory, and associating the digitized sample with the decoded information saved in memory.

32. The method of claim 30 further comprising generating a request to determine whether the multimedia content is available for download by the user based on the decoded information stored in the memory.

33. The method of claim 30 further comprising generating the download request based on the decoded information saved in memory.

34. The method of claim 23 further comprising indicating to the user whether the multimedia content is available for download.

35. The method of claim 34 further comprising generating the download request based on the indicated availability of the multimedia content.

36. The method of claim 23 wherein the information includes information selected from the group consisting of: a title of a song being rendered to the user, and an artist associated with the song.

37. The method of claim 23 wherein the information includes information selected from the group consisting of: a name of a video being rendered to the user, and an artist associated with the video.

38. The method of claim 23 wherein the information includes a URL that identifies a server that stores the multimedia content for download to the user.

39. The method of claim 23 further comprising sending the download request to a server in a communications network.

40. The method of claim 39 further comprising receiving a download of the multimedia content at a destination designated by the user responsive to the download request.

41. The method of claim 39 further comprising sending user profile information to a server in a network.

42. The method of claim 23 wherein receiving a broadcast radio signal comprises receiving a broadcast signal transmitted by a satellite.

43. The method of claim 23 wherein receiving a broadcast signal comprises receiving a broadcast signal transmitted by a commercial broadcast radio station.

44. A system for downloading multimedia content to a user of a wireless communications device comprising:
a consumer electronics device configured to:
receive a broadcast signal comprising multimedia content and information identifying the multimedia content;
render the multimedia content to the user; and
transmit a request to download the multimedia content based on the information; and
a server configured to:
receive the request to download the multimedia content; and
download the multimedia content to a destination device designated by a user of the consumer electronics device.

45. The system of claim 44 wherein the consumer electronics device is further configured to generate the download request based on the information identifying the multimedia content.

46. The system of claim 44 wherein the server is further configured to analyze the download request to determine whether the requested multimedia content is available for download to the user.

47. The system of claim 46 wherein the server is further configured to retrieve the requested multimedia content from a content server communicatively connected to the server.

48. The system of claim 44 wherein the consumer electronics device is a wireless communications device that communicates with the server via a wireless communications network.

49. The system of claim 44 further comprising a computing device associated with the user that is communicatively connected to the consumer electronics device and the server, and wherein the consumer electronics device transmits the download request to the server via the computing device.
